(19) United States
(12) Patent Application Publication
(10) Pub. No.: US 2016/0195975 A1
(43) Pub. Date: Jul. 7, 2016

(54) TOUCHSCREEN COMPUTING DEVICE AND METHOD

(71) Applicant: N-TRIG LTD., Kfar-Saba (IL)

(72) Inventors: Gary J. BAUM, Austin, TX (US); Navot OREN, Ramat-Efal (IL)

(73) Assignee: Microsoft Technology Licensing, LLC, Redmond, WA (US)

(21) Appl. No.: 14/654,552

(22) PCT Filed: Dec. 23, 2013
(86) PCT No.: PCT/IL2013/051051

§ 371 Date: Jun. 22, 2015

Related U.S. Application Data
(60) Provisional application No. 61/745,608, filed on Dec. 23, 2012.

(51) Int. Cl. G06F 3/041; G06F 3/0354; G06F 3/044

(52) U.S. Cl. CPC G06F 3/0416; G06F 3/044; G06F 3/0414; G06F 3/03545

(57) ABSTRACT

A touch screen computing device for generating visual feedback responsive to user input includes an electronic display operative to provide feedback responsive to user interaction with the touch screen, a digitizer system operative to receive input responsive to the user interaction and a host computer. The host computer includes an operating system, a display driver for communicating with the electronic display, a digitizer driver for communicating with the digitizer system, and a software module for establishing communication between the digitizer driver and the display driver while bypassing the operating system, wherein the software is operative to provide for generating primary visual feedback responsive to input from the digitizer system.

### FIELD AND BACKGROUND OF THE INVENTION

The present invention, in some embodiments thereof, relates to touch screen computing devices and, more particularly but not exclusively, to generating visual feedback on a touch screen in response to touch input.

Touch technologies are commonly used as input devices for a variety of electronic products. The usage of touch devices of various kinds is growing sharply due to the emergence of new mobile devices such as Personal Digital Assistants (PDA), tablet PCs, wireless flat panel displays (FPD), smart phones and other devices. Some of these devices are not connected to standard keyboards, mice or like input devices, which are deemed to limit their mobility. Instead there is a tendency to use touch input technologies of one kind or another.

Typically, a touch sensitive display screen can be operated with one or more fingers and/or a stylus. The finger or stylus can be used for selecting objects displayed on the screen, opening a document or scrolling within a window, and performing graphical operations such as creating, moving or otherwise manipulating objects, or the like. The finger or stylus can also be used for entering hand written data such as handwritten text and drawings. Typically, while a user enters hand written data, the computing device associated with the touch screen will produce digital ink, e.g. will generate visual feedback, e.g. inking, that follows the motion of the finger and/or stylus. The effect is like writing on paper with liquid ink. The recorded hand written or drawn data can be saved as a drawing or handwriting, or converted to typewritten text using handwriting recognition technology.

U.S. Pat. No. 7,843,439, entitled “Touch Detection for a Digitizer” assigned to N-trig Ltd., the contents of which is incorporated herein by reference, describes a detector for detecting both an electromagnetic stylus emitting a signal and interaction with finger touch. The detector typically includes a digitizer sensor with a grid of sensing conductive lines for sensing location of an electromagnetic stylus and a finger. The detector is capable of detecting simultaneous occurrences of multiple styluses and/or multiple finger touches.

### SUMMARY OF THE INVENTION

According to an aspect of some embodiments of the present invention there is provided a method for enhancing a user's experience while providing input to a touch screen with one or more fingers and/or a stylus. According to some embodiments of the present invention, a computing device and method provides for reducing and/or eliminating a visual lag in generating digital ink responsive to a user providing free style input. Optionally, the computing device and method is operated to reduce a visual lag in updating position of cursor or the like displayed on the touchscreen, and/or in a visual lag in erasing input during an erasing mode of a stylus.

According to an aspect of some embodiments of the present invention, there is provided a touch screen computing device for generating visual feedback responsive to user input comprising: an electronic display operative to provide feedback responsive to user interaction with the touch screen; a digitizer system operative to receive input responsive to the user interaction; and a host computer comprising: an operating system; a display driver for communicating with the electronic display; a digitizer driver for communicating with the digitizer system; and a software module for establishing communication between the digitizer driver and the display driver while bypassing the operating system, wherein the software is operative to provide for generating primary visual feedback responsive to input from the digitizer system.

Optionally, the software module establishes communication between at least one of: a low level driver adaptor, a miniport driver and an input device driver, and the display driver.

Optionally, the software module establishes communication between at least one of: a low level driver adaptor, a miniport driver and an input device driver, and a graphic processing unit.

Optionally, the digitizer driver is operative to provide coordinates of the user interaction to the display driver.

Optionally, the digitizer driver is operative to provide one of a hover state and a touch state of the user interaction.

Optionally, the digitizer driver is operative to provide pressure level associated with the user interaction.

Optionally, the software module is an application programming interface.

Optionally, the touch screen computing device includes an application, and the application is operative to provide instructions for configuring generation of the primary visual feedback.

Optionally, the application is operative to provide instructions for when not to generate the primary visual feedback.

Optionally, the display driver and the digitizer driver are also operative to communicate with the operating system and wherein the primary visual feedback is replaced by a second visual feedback generated in response to reporting the same input from the digitizer system to the operating system and obtaining instruction from the operating system.

Optionally, the second visual feedback is generated after the primary visual feedback is generated.

Optionally, the second visual feedback is visually distinct from the primary visual feedback.

Optionally, the primary visual feedback is operative to fill a visual gap between a currently location of the user interaction on the touch screen and an updated location of the second visual feedback.

Optionally, the primary visual feedback is an ink trail.

Optionally, the digitizer system is a capacitive based digitizer system.

Optionally, the user interaction is at least one of one or more fingertips or a stylus.

According to an aspect of some embodiments of the present invention there is provided a method for generating visual feedback on a touch screen responsive to user input, the method comprising: receiving input from a digitizer system of the touch screen responsive to a user interacting with the touch screen; reporting the input to a display driver of a host computer associated with the touch screen via communication that bypasses an operating system of the host computer; reporting the same input to the operating system of the host computer; providing a first visual feedback responsive to the input reported to display driver via communication that bypasses the operating system; and providing a second visual feedback responsive to the same input reported to the operating system.

Optionally, the first visual feedback precedes the second visual feedback.

Optionally, the first visual feedback is provided before the second visual feedback.

Optionally, the first visual feedback is operative to fill a visual gap between a currently location of user interaction on the touch screen and an updated location of the second visual feedback.

Optionally, the second visual feedback replaces the first visual feedback of the same input.

Optionally, the first visual feedback is defined to be visually distinct from the second feedback.

Optionally, the first visual feedback is an ink trail.

Optionally, the ink trail follows free style input provided by a user on the touch screen.

Optionally, the first visual feedback is displayed with a thinner line as compared to the second visual feedback.

Optionally, the first visual feedback is removal of ink generation in accordance with the input.

Optionally, the first and second visual feedback is provided in response to input from the digitizer system reporting that the user is interacting with the digitizer system by touching the touch screen.

Optionally, the first and second visual feedback is provided in response to stylus interaction with the digitizer system.

Optionally, the input provided by the digitizer system is coordinates of interaction with the touch screen.

Optionally, the input provided by the digitizer system includes indication whether the user interaction is by touch or hover.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows three simplified graphical representations of ink generation in response to free style input to a touch screen with a stylus in accordance to some embodiments of the present invention;

FIG. 2 is a simplified block diagram of a touch screen computing device in accordance with some embodiments of the present invention;

FIG. 3 is a simplified block diagram showing data flow between different layers of a computing device in accordance with some embodiments of the present invention; and

FIG. 4 is a simplified flow chart of an exemplary method for providing instructions for ink generation in accordance with some embodiments of the present invention.

### DESCRIPTION OF SPECIFIC EMBODIMENTS OF THE INVENTION

The present invention, in some embodiments thereof, relates to touch screen computing devices and, more particularly, but not exclusively, to generating ink on a touch screen in response to touch input.

Typically, a user prefers and/or expects a touch screen to provide a same feel as when writing with pen and paper. The present inventor has found that a user's experience when operating a touch screen may be compromised by noticeable delays in generating visual feedback, the visual signs also referred to as ink, digital ink, or inking, as the user moves a finger or stylus across the touch screen to provide input. For example, when drawing a line, an ink trail generated on the touch screen may lag behind a finger and/or stylus rather than follow it immediately. Often, the lag of the computing device is more noticeable to a user while providing handwritten and/or free style input, and possibly even more so when providing input with a stylus.

The noticeable delays may be due to a tendency of a user to operate with faster hand movements while providing the free stylus input, as compared to when using the finger or stylus to move a cursor. In addition, a user typically may expect and/or require more accurate feedback while providing the free style input. Optionally, processing free style input may require more time as compared to other types of input.

The present inventor has found that much of the delay in ink generation may occur at the level of the operating system, application, graphic interface and/or graphic library that may typically process the input received from the digitizer system prior to generating ink on the touch screen. The present inventor has found that a user's experience can be enhanced by providing temporary feedback to the user before the computing system has finished processing the touch input received. Typically, the temporary feedback is in the form of temporary ink that is generated on the touch screen without processing the touch input at a level and/or layer of the operating system and applications. Optionally, the inking is subsequently updated responsive to processing by the operating system, application, graphic interface and/or graphic library.

According to some embodiments of the present invention, coordinates for inking as received by a driver from a digitizer system are forwarded both directly to a graphics buffer, graphics controller, and/or a display adaptor for generating temporary inking on the display screen, and to the graphics controller through standard channels including one or more of the drivers, including the operating system, Application Programming Interfaces (APIs) and/or applications. Typically, digital ink is generated on the display screen both in response to direct communication between the digitizer system driver and the graphics controller, and in response to input from the digitizer system driver to the operating system, application, back to the operating system and then to the display drivers.

As used herein, the term temporary ink means digital ink that is generated in response to communication, e.g. direct communication between the digitizer system driver and the graphics controller. Typically, an API at the driver level is used to manage communication between the drivers. Typically, the temporary ink fills in a visual gap that may otherwise appear between current coordinates of a finger or stylus interacting with the touch screen, and ink generated in response to input obtained via the operating system. Optionally, the temporary ink is defined to have a different visual appearance than ink generated in response to input obtained via the operating system.

Optionally, a different thickness of a stroke, color of the stroke, pattern of the stroke and/or style of the stroke, e.g. solid, dashed or dotted is used for the temporary ink. Typically, appearance of the temporary ink is updated during each sampling cycle of the touch screen. Optionally, the temporary ink is actively erased, e.g. in instances when the temporary ink appears outside a designated area of an active application, or in situations where the application determines not to generate the ink.

As used herein the term persistent ink means digital ink that is generated after processing at one or more layers above the driver layer, e.g. API layer, application, graphics sub-system and/or operating system. Persistent ink is not meant to mean ink that cannot be removed and/or erased, but is rather meant to provide terminology that distinguishes between temporary ink that is generated without processing at one or more layers above the driver layer and ink that is generated by the application in response to user input on the touch screen.

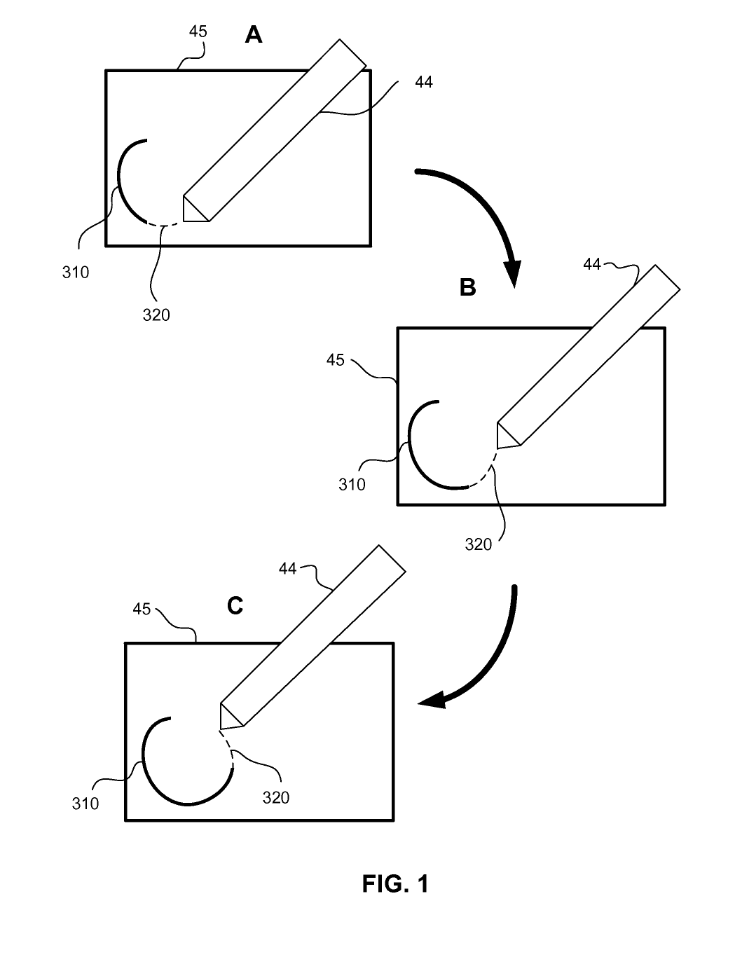

Referring now to the drawings, FIG. 1 illustrates a progression of ink generation in response to free style input to a touch screen with a stylus, in accordance to some embodiments of the present invention. FIG. 1 shows three consecutive times during the free style input. Time A is followed by time B which is followed by Time C. Typically, as a stylus 44 writes on a touch screen 45, digital ink 310 is generated by touch screen 45. Typically, persistent ink trail 310 follows the motion of the stylus 44, e.g. the tip of the stylus 44, but might lag behind the stylus 44. The lag may be due to the time it takes for the operating system and application to process the input received from the stylus and/or the touch screen.

According to some embodiments of the present invention, there is provided a computing device and method for providing immediate feedback to a user by generating a temporary ink trail 320 while the input is being processed at the level of the operating system and applications. Typically, temporary ink trail 320 fills in a gap that would otherwise be formed between a location of stylus 44 and digital ink trail 320. According to some embodiments of the present invention, temporary ink trail 320 more closely follows a current location of stylus 44 as compared to persistent ink trail 310. According to some embodiments of the present invention, as stylus 44 advances through its motion, e.g. from A to B to C, a portion of a stroke that was first inked with temporary ink trail 320 is replaced by persistent ink trail 310. Optionally, due to processing of the input, ink trial 310 is drawn as smoother trail as compared to temporary ink 320 and/or in a different location. The provided feedback may be distinguishable from the actual response of the application, and may disappear if not re-drawn by the application. Optionally, temporary ink trail 320 is erased and/or made to disappear and is not replaced by persistent ink trail 310.

According to some embodiments of the present invention, temporary ink trail 320 is made to be distinguishable from persistent ink trail 310 and to disappear if not re-drawn by the application. Optionally, ink trail 320 is displayed as a thinner line than persistent ink trail 310. Optionally, temporary ink trail 320 may be displayed as a dashed line and/or with a different color than the color used for ink trail 310. Typically, a difference in a style of a line is used so that the user can differentiate between persistent ink 310 that is generated from input that has been processed by the operating system and application, and temporary ink trail 320 that is generated without processing by the operating system and application. Optionally, the visual feedback generated is other than an ink trail, e.g. a character, or a geometric object.

According to some embodiments of the present invention, temporary ink 320 provides more prompt feedback to the user, regardless of the lag caused by processing time by the API layer, application, graphics sub-system and host computer. This experience more closely matches that of a pencil or a ballpoint pen on paper ink creation.

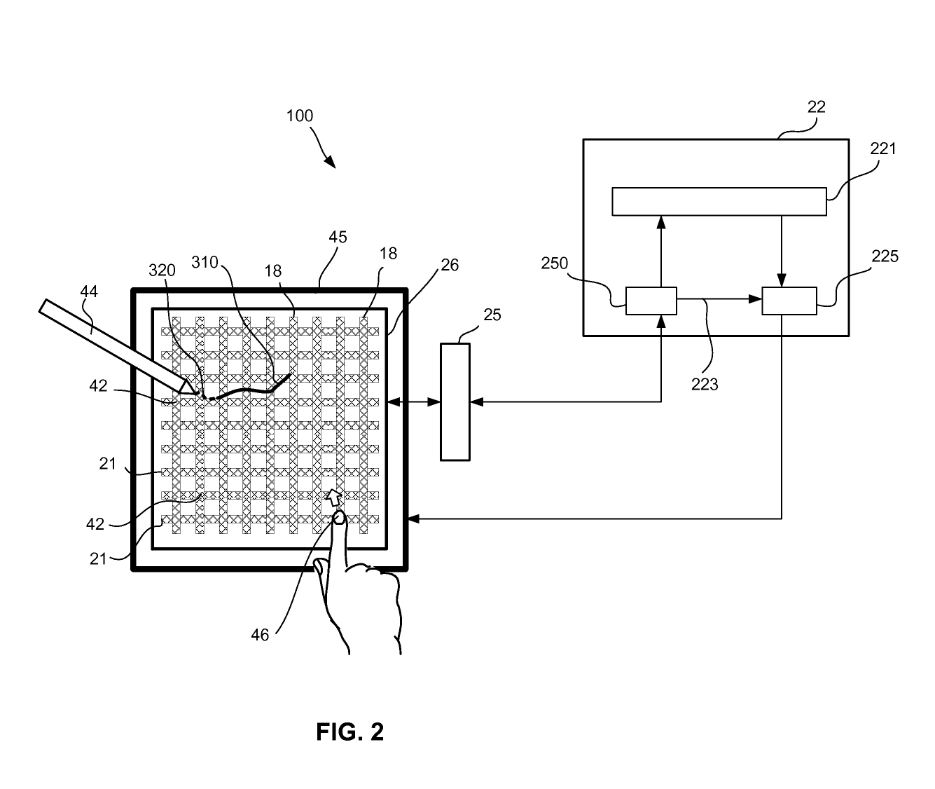

Reference is now made to FIG. 2 showing a simplified block diagram of a touch screen computing device in accordance with some embodiments of the present invention. According to some embodiments of the present invention, a touch screen computing device 100, includes a host computer 22 associated with a digitizer sensor 26 overlaid on a display 45. Typically, digitizer sensor 26 and display 45 together form the touch screen. Typically, digitizer sensor is transparent so that it is suitable for being overlaid on display 45. Optionally, display 45 is a flat panel display. Optionally, digitizer sensor is a capacitive based sensor that is operative to detect input by a stylus 44 transmitting an electromagnetic signal and/or touch by one or more fingertips 46 or other conductive objects. In some exemplary embodiments, digitizer sensor 26 is a grid based sensor that includes a set of horizontal conductive lines 21 and a set of vertical conductive lines 18 that together form junctions 42. Optionally, digitizer sensor is an in-cell, on-cell, out-cell, transparent sensor or any other non-capacitive sensor technology, including but not limited to resistive, IR, ultrasonic, optical, or the like.

According to some embodiments of the present invention, input provided by stylus 44 and/or one or more fingertips 46 is picked up by sensor 26, e.g. one or more horizontal conductive lines 21 and/or vertical conductive lines 18, and detected with digitizer circuitry 25. Typically, digitizer circuitry 25 also operates as a controller of digitizer sensor 26. Typically, output from digitizer circuitry 25 is reported to host 22. Typically, digitizer sensor 26 and digitizer circuitry 25 together form and/or are referred to as a digitizer system. Typically, the output provided by digitizer circuitry 25 includes coordinates of a stylus 44 and/or coordinates of one or more fingertips 46 interacting with digitizer sensor 26. Optionally, digitizer circuitry 25 additionally reports a hover or touch state for stylus 44 and/or fingertip(s) 26. Optionally, digitizer circuitry 25 additionally identifies coordinates as originating from stylus 44 or fingertip 46. Optionally, digitizer circuitry 25 additionally reports a pressure applied on a tip of stylus 44. Typically, digitizer circuitry 25 uses both analog and digital processing to processes signals and/or data picked up from sensor 26. Optionally, some and/or all of the functionality of digitizer circuitry 25 are integrated and/or included in host 22.

According to some embodiments of the present invention, stylus 44, fingertip 46 and/or other physical objects operative to interact with digitizer sensor 26 are used for pointing, painting, writing (optionally followed by hand writing recognition) and any other activity that is available for user interaction with the device. Typically, device 100 can detect single or multiple finger touches. Optionally, system 100 can detect several electromagnetic objects, either separately or simultaneously. Optionally, fingertip touch detection may be implemented simultaneously with stylus detection.

Typically, host 22 includes one or more drivers 250 for receiving input from digitizer circuitry 25 and managing communication between digitizer circuitry 25 and an operating system 221 of host 22. Optionally, one or more drivers 250 also operate to provide commands and to control operation of digitizer circuitry 25. Typically, input to drivers 250 is forwarded to an operating system 221 of host 22. Typically, operating system 221 calls and/or manages one or more applications, a graphic interface and/or graphic library to provide commands to a graphic controller, graphic buffer and/or display driver 225 for updating display 45 responsive to input provided by the user. At times, updating of display 45 responsive to input from digitizer circuitry 25 may be delayed due to the time it takes for the operating system, one or more applications, graphic interface and/or graphic library to operate and/or process the input received.

According to some embodiments of the present invention, an API is defined to provide direct communication 223 between digitizer driver 250 and graphic controller and/or graphic buffer 225 without first being processed by the operating system, or applications. According to some embodiments of the present invention, direct communication 223 provides for generating temporary inking in response to input from stylus 44 and/or finger 46. Typically, communication by standard channels is also maintained so that input can be concurrently processed by operating system 221 with one or more applications. Typically, persistent ink, e.g. persistent ink trail 310 generated after processing replaces the temporary ink, e.g. temporary ink trail 320 generated immediately by direct communication 223 at the driver level. Optionally, temporary ink is only generated during a touch state of a finger. Optionally, temporary ink is only generated during a touch state of a stylus. According to some embodiments of the present invention, when some and/or all of functionality of digitizer circuitry 25 is included in host 22, temporary ink is generated by communicating input obtained from digitizer sensor 26 to graphic controller 225 prior to processing the input at the level of the operating system and/or application.

In some exemplary embodiments, pixel(s) or an area of display 45 is illuminated and/or activated, e.g. digital ink is generated in accordance with coordinates provided by driver 250. In some exemplary embodiments, the pixel(s) or area is activated for a defined, e.g. pre-defined period of time. Optionally, the pixels are deactivated after 75 msec to 150 msec if indication to maintain the activation is not repeated by an active application, e.g. to provide persistent ink in that area. For example, if the user draws outside a permitted area of an active screen, graphic controller 250 may generate temporary ink e.g. by drawing a temporary ink trail 320, which may disappear once operating system 221 with application analyzes the touch and determines that the ink trail should not be drawn outside the active window. According to some embodiments of the present invention, an Application, e.g. a drawing Application and/or a word processing Application is used to configure the properties of the temporary ink 320 and/or to provide instructions for not generating inking in specific situations. Optionally, the Application provides instruction to generate ink only in response to fast movement of a stylus or finger but not in response to slow movement.

It is noted that touch screen computing device 100 may include smart phones, Tablet PCs, pen enabled lap-top computers, personal digital assistants (PDAs), or any hand held devices such as digital audio players or mobile phones. Optionally, touch screen computing device 100 is used for entertainment applications, such as a playing board or a tabletop computer.

It is noted that methods for fingertip touch detection may similar to those described for example in incorporated U.S. Pat. No. 7,843,439 and/or in U.S. Pat. No. 7,372,455 entitled “Touch detection for a digitizer” which is hereby incorporated herein by reference.

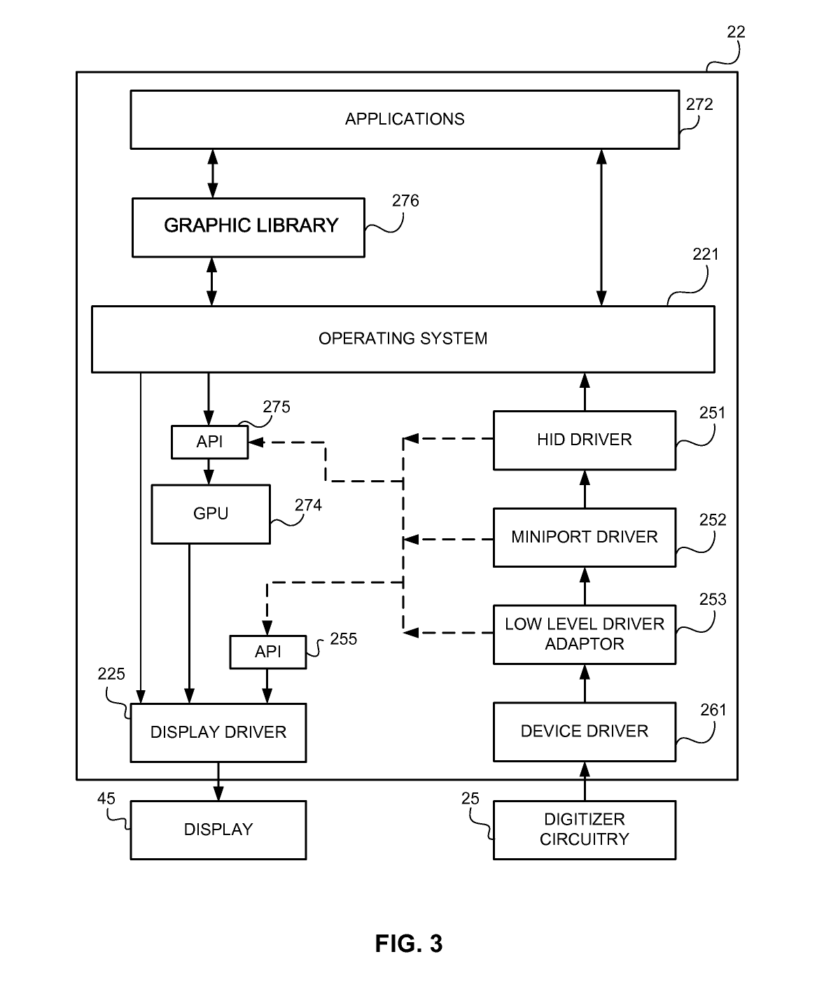

Reference is now made to FIG. 3 showing a simplified block diagram of data flow between different layers of a computing device in accordance with some embodiments of the present invention. According to some embodiments of the present invention, digitizer circuitry 25 reports coordinates of user interaction to device driver 261 of a host computer 22. Optionally, digitizer circuitry 25 reports additional information, e.g. hover or touch operational state, finger or stylus, and/or pressure level to driver 261 of host computer 22. Typically, information reported to device driver 261 is communicated to operating system 221 via a low level driver adaptor 253, a miniport driver 252 and/or a Human Interface Device (HID) driver 251. Optionally, host computer 22 uses an input device driver other than an HID driver 251. Information provided by digitizer circuitry 25 is further processed at the level of operation system 221 and also at the level of one or more applications 272 executed by computing device 22, graphic interface and graphic library 276. Typically, one or more of the operating system 221 and/or graphic processing unit (GPU) 274 communicates with display driver 225 for updating the data displayed on display 45. Optionally, communication between operating system 221 and GPU 274 is through an API 275.

According to some embodiments of the present invention, input provided by digitizer circuitry 25 is concurrently communicated to the display driver 225 via a communication line between drivers. Optionally, input provided by digitizer circuitry 25 is communicated to the display driver 225 via a communication line between display driver 225 and low level driver adaptor 253, miniport driver 252, and/or HID driver 251. According to some embodiments of the present invention, an API 255 at the driver level is defined to communicate with display driver 225 and/or to manage communication between one of low level driver adaptor 253, miniport driver 252, and/or HID driver 251, and display driver 225. Optionally, one of low level driver adaptor 253, miniport driver 252, and/or HID driver 251 provides coordinates and optionally additional data directly to GPU 274. Optionally, API 275 is defined to communicate between one of low level driver adaptor 253, miniport driver 252, and/or HID driver 251 and GPU 274. In some exemplary embodiments, API 255 provides instructions to display driver 225 to generate temporary ink only in response to touch input from stylus 44 and/or a finger 46 and not in response to hover input. Optionally, API provides instructions for controlling the ink generation, e.g. color, width and/or style. In some exemplary embodiments, communication at the driver level can also be used during an erasing operational mode. Optionally, areas as indicated by digitizer sensor 26 and digitizer circuitry 25 can be temporarily erased by displaying the erased area in gray or with increased translucency. Optionally, temporary erasing also improves the user experience by providing faster feedback to the user of what is being erased. In some exemplary embodiments, an Application communicates with API 255, API 275, GPU 274 and/or display driver 225 to define temporary ink behavior and/or configuration.

In some exemplary embodiments, information related to temporary ink generation is stored in a graphics buffer of display driver 225 so that GPU 274 can later display or erase the temporary line, based upon setting bits in the buffer as active or inactive. Alternatively, the temporary display of the touch stylus location events may be referred to as persistent. Optionally an API can be defined to deal with temporary ink appearing outside of an active window of an application.

It will be appreciated that the disclosure can be used also in systems that do not have GPU 274 and API 275. In further alternatives, GPU 274 and API 275 may exist but may be accessed only from operating system 221. In such cases, information may be sent form HID driver 251 or the like, miniport driver 252 or low level driver adaptor 253 to display driver 225 through API 255.

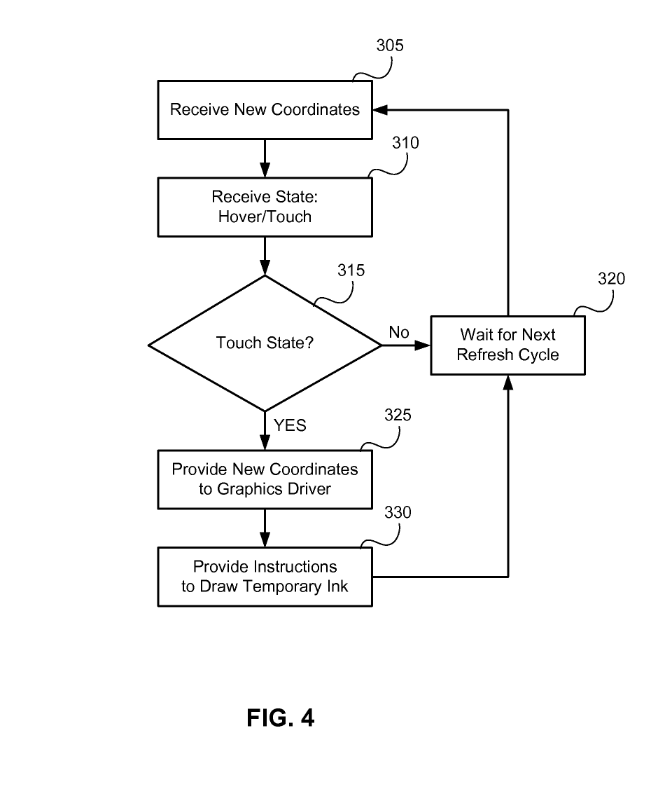

Reference is now made to FIG. 4 showing a simplified flow chart of an exemplary method for providing instructions for generating an ink trail in accordance with some embodiments of the present invention. According to some embodiments of the present invention, an API receives coordinates of input (block 305) from a driver associated with digitizer sensor 26, and may also receive information indicating if that coordinate was obtained during a hover or touch state of a user interaction, e.g. finger 46 or stylus 44 (block 310). Optionally, the API additionally receives information and/or indication whether the coordinate was obtained from a stylus 44 or from fingertip 46. Optionally, the API determines if the coordinate was obtained during a touch state (block 315) and only provides the coordinates to the graphics driver if the coordinate was obtained during a touch state (325). According to some embodiments of the present invention, the API receives instructions from an Application for configuring one or more properties of the temporary ink, e.g. color, width or pattern and/or provides instructions for not generating temporary ink in specific situations. According to some embodiments of the present invention, coordinates provided to the graphics driver are used to generate temporary ink (block 330). Optionally, coordinates are stored in a graphic buffer and used to draw an ink trail on or between provided coordinates. According to some embodiments of the present invention, the API waits for a subsequent refresh cycle of the display (block 320) and repeats this process so that temporary ink generation can continue to be generated.

The terms “comprises”, “comprising”, “includes”, “including”, “having” and their conjugates mean “including but not limited to”.

The term “consisting of” means “including and limited to”.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

1. A device comprising:
a display configured to provide feedback responsive to user interaction with the display;
a digitizer system configured to receive input responsive to the user interaction; and
a host computer comprising:
an operating system;
a display driver configured for communicating with the display;
a digitizer driver configured for communicating with the digitizer system; and
a software module for establishing communication between the digitizer driver and the display driver while bypassing the operating system, wherein the software is configured to provide for generating primary visual feedback responsive to input from the digitizer system,
wherein the display driver and the digitizer driver are also configured to communicate with the operating system and wherein the primary visual feedback is replaced by a second visual feedback generated in response to reporting the same input from the digitizer system to the operating system and obtaining instruction from the operating system, and wherein the primary visual feedback is defined to be visually distinct from secondary visual feedback.

2. The device according to claim 1, wherein the software module establishes communication between at least one of: a low level driver adaptor, a miniport driver and an input device driver, and the display driver.

3. The device according to claim 1, wherein the software module establishes communication between at least one of: a low level driver adaptor, a miniport driver and an input device driver, and a graphic processing unit.

4. The device according to claim 1, wherein the digitizer driver is configured to provide coordinates of the user interaction to the display driver.

5. The device according to claim 4, wherein the digitizer driver is configured to provide one of a hover state and a touch state of the user interaction.

6. The device according to claim 4, wherein the digitizer driver is configured to provide pressure level associated with the user interaction.

7. The device according to claim 1, wherein the software module is an application programming interface.

8. The device according to claim 1 comprising an application, wherein the application is configured to provide instructions for configuring generation of the primary visual feedback.

9. The device according to claim 1 comprising an application, wherein the application is configured to provide instructions for when not to generate the primary visual feedback.

10. (canceled)

11. The device according to claim claim 1, wherein the second visual feedback is generated after the primary visual feedback is generated.

12. (canceled)

13. The device according to claim 1, wherein the primary visual feedback is configured to fill a visual gap between a currently location of the user interaction on the touch screen and an updated location of the second visual feedback.

14. The device according to claim 1, wherein the primary visual feedback is an ink trail.

15. The device according to claim 1, wherein the digitizer system is a capacitive based digitizer system.

16. The device according to claim 1, wherein the user interaction is at least one of one or more fingertips or a stylus.

17. A method comprising:
receiving input from a digitizer system of a touch screen responsive to a user interacting with the touch screen;
reporting the input to a display driver of a host computer associated with the touch screen via communication that bypasses an operating system of the host computer;
reporting the same input to the operating system of the host computer;
providing a first visual feedback responsive to the input reported to display driver via communication that bypasses the operating system; and
providing a second visual feedback responsive to the same input reported to the operating system, wherein the first visual feedback is defined to be visually distinct from the second visual feedback.

18. The method according to claim 17, wherein the first visual feedback precedes the second visual feedback.

19. The method according to claim 17, wherein the first visual feedback is provided before the second visual feedback.

20. The method of claim 19, wherein the first visual feedback is configured to fill a visual gap between a currently location of user interaction on the touch screen and an updated location of the second visual feedback.

21. The method of claim 17, wherein the second visual feedback replaces the first visual feedback of the same input.

22. (canceled)

23. The method of claim 17, wherein the first visual feedback is an ink trail.

24. The method according to claim 23, wherein the ink trail follows free style input provided by a user on the touch screen.

25. The method according to claim 23, wherein the first visual feedback is displayed with a thinner line as compared to the second visual feedback.

26. The method according to claim 17, wherein the first visual feedback is removal of ink generation in accordance with the input.

27. The method according of claim 17, wherein the first and second visual feedback is provided in response to input from the digitizer system reporting that the user is interacting with the digitizer system by touching the touch screen.

28. The method according to claim 27, wherein the first and second visual feedback is provided in response to stylus interaction with the digitizer system.

29. The method according to claim 17, wherein the input provided by the digitizer system is coordinates of interaction with the touch screen.

30. The method according to claim 29, wherein the input provided by the digitizer system includes indication whether the user interaction is by touch or hover.

31. The method of claim 17, wherein the first visual feedback is displayed with a different color as compared to the second visual feedback.

32. The method of claim 17, wherein the first visual feedback is displayed with a different line style as compared to the second visual feedback.
